(19) United States
(12) Patent Application Publication
(10) Pub. No.: US 2004/0096041 A1
(43) Pub. Date: May 20, 2004

(54) Method for determining the position of at least one subscriber terminal of a radio communications system, and a corresponding radio communications system

(76) Inventors: Mark Beckmann, Braunschweig (DE); Michael Eckert, Braunschweig (DE); Martin Hans, Hildesheim (DE); Andreas Otte, Celle (DE)

Correspondence Address: BELL, BOYD & LLOYD, LLC, P. O. BOX 1135, CHICAGO, IL, 60690-1135, US

(21) Appl. No.: 10/398,699

(22) PCT Filed: Oct. 4, 2001
(86) PCT No.: PCT/DE01/03399

(30) Foreign Application Priority Data
Oct. 9, 2000 (DE) 10049794.2

(51) Int. Cl. H04M 1/24

(52) U.S. Cl. 379/1.01

(57) ABSTRACT

The aim of the invention is to determine the position of at least one subscriber terminal (MP1) of a radio communications system (MCS). To this end, the invention provides that during and/or after a change in responsibility from a first radio network control unit (RNC1) to a second radio network control unit (RNC2), at least one interrogation signal (ME1), which had been originally directed toward the first radio network control unit (RNC1) in order to determine the position of the respective subscriber terminal (MP1) to be located, is relayed to the second radio network control unit (RNC2).

In a mobile communications system such as one based on the GSM (global system for mobile communication) or UMTS (universal mobile telecommunication system) standard, it may be of interest to selectively determine the current location of a specific subscriber terminal, and in particular of a mobile terminal.

The object of the invention is to show how the position of a specific subscriber terminal in a mobile communications system can be selectively determined in a simple and reliable way. According to the invention, this object is achieved by a procedure in accordance with the features of claim 1 and by a mobile communications system with the features of claim 8.

The position of a specific subscriber terminal can be reliably and simply determined by forwarding an interrogation signal after determining the position of a specific subscriber terminal from the first radio network controller originally responsible for the terminal to the second radio network controller now responsible for it. It is even possible to determine efficiently the changing locations of a mobile subscriber terminal, preferably a mobile terminal such as a mobile phone, in different radio cells for which the different groups of base stations for which are coordinated by different radio network controllers.

Other features of the invention will emerge from the sub-claims.

The invention and its features will now be described with reference to drawings, in which

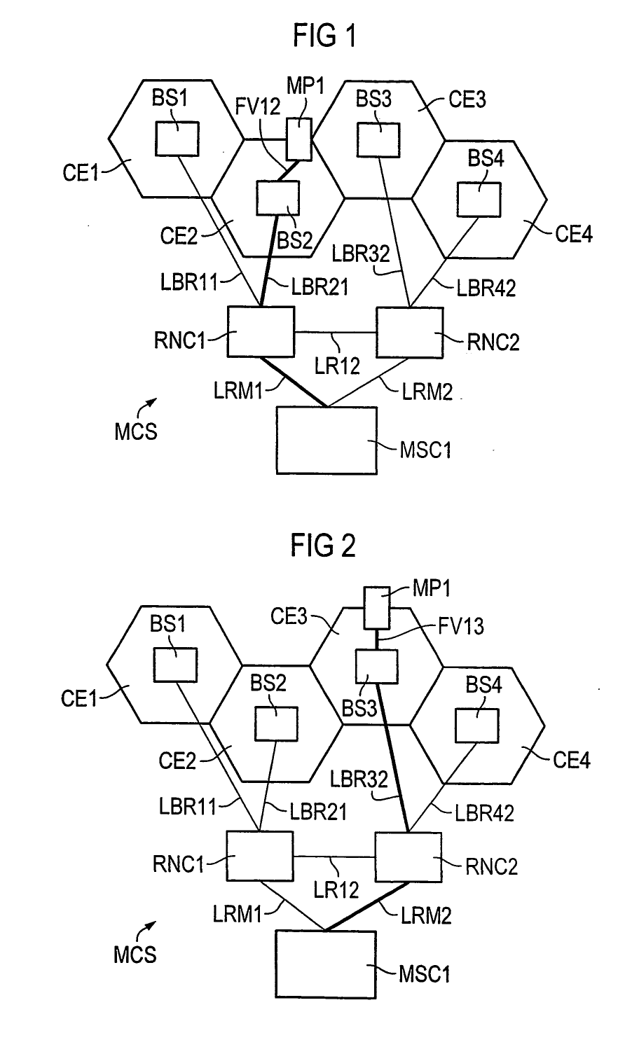

FIG. 1 is a schematic diagram of the functional radio link between the components of a mobile communications network, particularly a mobile radio system, for a specific subscriber terminal to be located in a first radio cell whose base station is assigned to a first radio network controller,

FIG. 2 is a schematic diagram of a first possibility of a functional radio link for the subscriber terminal according to FIG. 1 in a second radio cell, different from that in FIG. 1, in this mobile communications network whose base station is now controlled by another, second radio network controller,

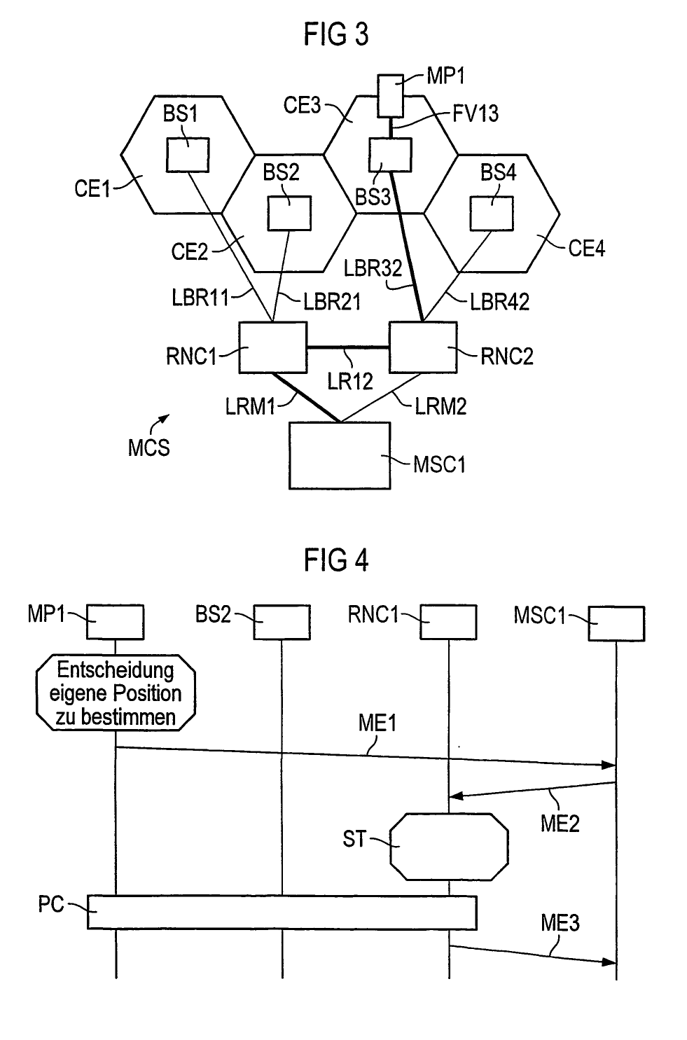

FIG. 3 is a schematic diagram of a second possibility of a functional radio link for the subscriber terminal according to FIG. 1 in a second radio cell, different from that in FIG. 1, in this mobile communications network whose base station is now controlled by another, second radio network controller,

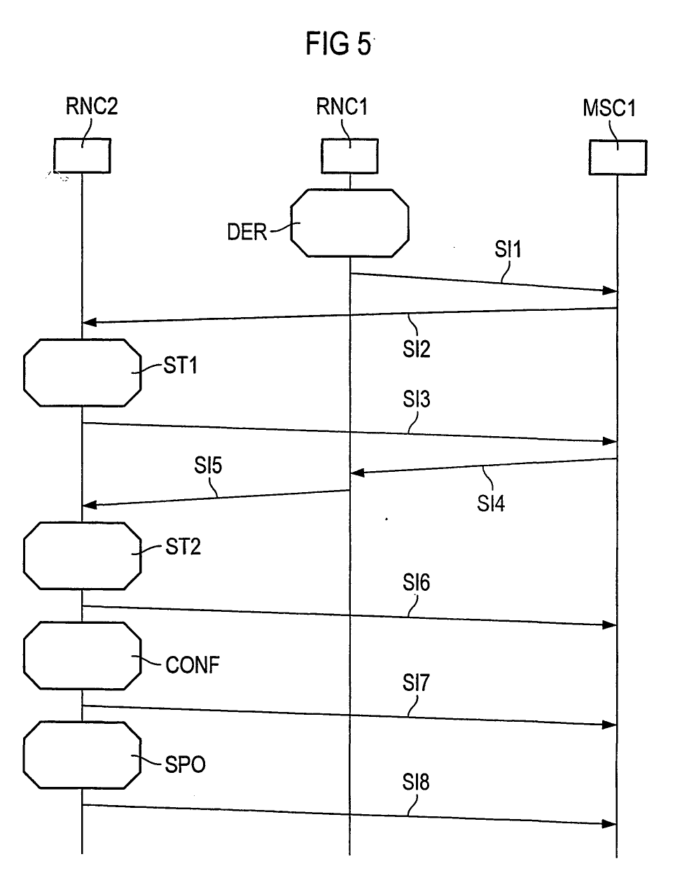

FIG. 4 is a schematic diagram of the signaling scheme for determining the position of the subscriber terminal to be located between the interfaces of this subscriber terminal, the base station in its current radio cell, the current assigned radio network controller for administering this base station, and a higher-ranking network unit for coordinating the communication links of several radio network controllers,

FIG. 5 is a schematic diagram of the functional signaling process between the various components of the mobile communications system in FIG. 1 in accordance with the first variant of the procedure according to the invention for determining the position of the subscriber terminal as per FIG. 1 which changes from its first radio cell to the second radio cell as per FIG. 2,

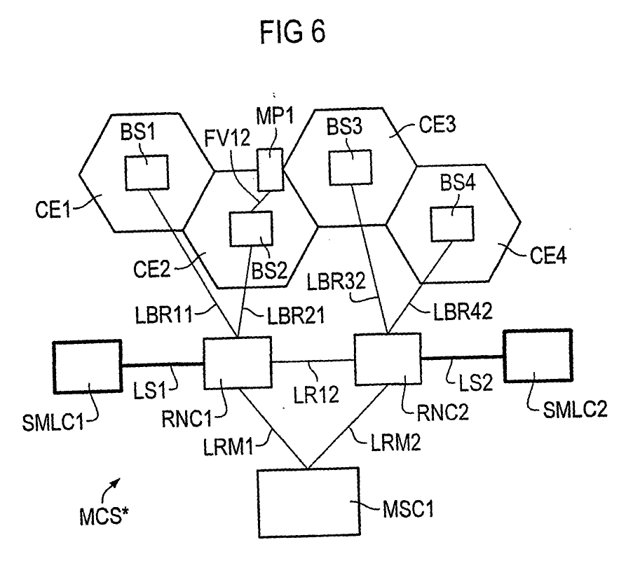

FIG. 6 is a schematic diagram of the structure of a mobile communications system modified compared with FIG. 3 for implementing a second variant of the procedure according to the invention, and

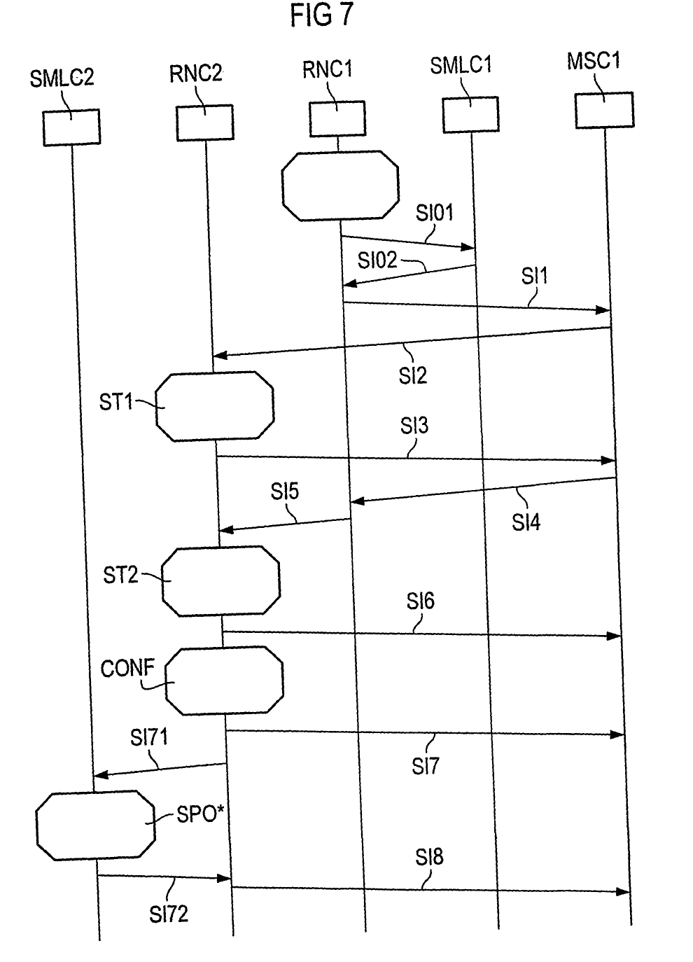

FIG. 7 is a schematic diagram of the functional signaling process between the various components of the mobile communications system as per FIG. 6 in accordance with the second variant of the procedure according to the invention.

Elements with the same function and operation are labeled with the same references in FIGS. 1 to 7.

In the cellular mobile communications system MCS in FIG. 1, base stations such as BS1 to BS4 cover radio cells such as CE1 to CE4. A radio cell is specifically (i.e. selectively) assigned to each base station. Within a radio cell such as CE2 a mobile phone such as MP1 may have a radio link with the assigned base station such as BS2 that services this current radio cell. The mobile radio system is preferably set up on the basis of the UMTS standard (universal mobile telecommunication system). One or more base stations are connected as a group via fixed network connections and/or radio links with a common radio network controller. In practice, a mobile radio system preferably has several groups of one or more base stations, whereby each group is assigned a radio network controller to coordinate radio traffic within the group.

In FIG. 1, for example, a first group of base stations is formed by the two base stations BS1 and BS2. These are jointly linked to the first radio network controller RNC1 via relevant fixed network connections LBR11, LBR21. Accordingly, the two base stations BS3, BS4 are jointly linked via fixed network connections LBR32, LBR42 to a second radio network controller RNC2 as a second group and are controlled and administered by this controller. Such a radio network controller and its assigned base stations are called a radio network subsystem (RNS). The radio network controllers such as RNC1, RNC2 take over control, for example, of the radio resources within the relevant subsystem. A particular mobile phone is therefore always controlled from precisely one radio network controller. With reference to this specific mobile phone, this radio network controller is then called a serving radio network controller (SRNC). With reference to this mobile phone, the entire subsystem is called a serving radio network subsystem (SRNS). One or more radio network controllers such as RNC1, RNC2 are connected via further fixed network and/or radio links such as LRM1, LRM2 to a higher-ranking network unit such as a mobile switching center (MSC) and/or a serving GPRS support node (SGSN). MSCs and/or SGSNs perform control functions with respect to the mobile phones. For example, they ensure that incoming calls from external networks are ultimately forwarded to the relevant base station that has a radio link with the required mobile phone. In addition, the radio network controllers such as RNC1, RNC2 may be directly connected to one another via a fixed network or radio link such as LR12. Such a direct connection may be used for SRNS relocation among other things.

The function of SRNS relocation is described below:

In FIG. 1, mobile phone MP1 is located for example in radio cell CE2. It has a first radio link FV12 via its air interface to base station BS2. The current radio cell CE2 is therefore covered and served by base station BS2 which is connected via a first interface LBR21 with the first radio network controller RNC1. Radio network controller RNC1 is connected via fixed network connection LRM1 with the hierarchically high-ranking network unit MSC1, which may be either a mobile switching center or a serving GPRS support node. The entire connection between mobile phone MP1 and the higher-ranking network unit MSC1, which coordinates the radio network controllers, is shown as thicker lines and therefore consists of FV12, LBR21, LRM1.

If mobile phone MP1 now moves from cell CE2 to cell CE3, then in accordance with FIG. 2 mobile phone MP1 will be connected via a second radio link FV13 with base station BS3, which in turn is connected with the second fixed network connection LBR32 with the second radio network controller RNC2. Such a change of radio link between a mobile phone and a base station from a first base station to a second base station is generally known as handover. During and/or after such a handover of the mobile phone from the cell area of a first base station to the cell area of a different base station the serving RNC (in other words the responsibility of the radio network controller) may be changed in addition or independently. This means that in this exemplary embodiment the originally assigned radio network controller RNC1 no longer controls the radio link to mobile phone MP1. Instead, radio network controller RNC2 is now responsible for control. This is because base station BS3 in the new cell CE3 now belongs to a second group of base stations that are controlled and coordinated from the second radio network controller RNC2. Radio network controller RNC2 directly sets up the communication path via fixed network connection LRM2 for voice and/or data exchange with the higher-ranking network unit MSC1. Such a change of radio network controller is known as SRNS relocation. The entire connection between the mobile phone to be located and MSC/SGSN is therefore formed from FVl3, LBR32, LRM2, which is shown by thicker lines in FIG. 2.

SRNS relocation is independent of a handover. This means that SRNS relocation may take place much later than the handover from one base station to the next. Handover in which the mobile phone changes from radio link FV12 with base station BS2 to radio link FV13 with base station BS2 can take place, for example, while, as before, the responsible first radio network controller RNC1 remains responsible for communication with the higher-ranking network unit MSC1 and not yet the second radio network controller RNC2. The entire connection between mobile phone MP1 and the higher-ranking network unit MSC then comprises FV13, LBR32, LR12 and LRM1, as shown by thicker lines in FIG. 3. At a later time the higher-ranking network unit MSC1 may decide to change the serving RNC; in other words, the serving RNC1 here can pass control to the other, second radio network controller RNC2 so that the entire communication connection then corresponds again to that in FIG. 2.

During changeover of the serving RNC (SRNS relocation), the information needed for controlling the mobile phone is transferred from the old radio network controller, in this case RNC1, to the new radio network controller, in this case RNC2. Examples of such information include the configuration of existing data transfer, capabilities of the mobile phone, etc.

Documents TS 25.305 “Stage 2 Functional Specification of Location Services in UTRAN” and TS 23.171 “Functional Stage 2 Description of Location Services in UMTS” describe location services in detail. Location services are taken to mean the ability to determine the position of a mobile phone. This can be done by measuring radio signals either in the mobile phone or in the base station. The precise function of the methods for determining positions is detailed there.

A request to determine the position of a mobile phone can be made by the network, by the mobile phone itself or by another mobile phone. FIG. 4 is a schematic diagram of the procedure for determining the position. It is assumed here for example that mobile phone MP1 in FIG. 1 requests its own position. This is done with a first message ME1 which is sent from mobile phone MP1 via radio link FV12, connection LBR21 between base station BS2 and radio network controller RNC1 and connection LRM1 to the higher-ranking network unit MSC1. The higher-ranking network unit MSC1 then sends a position determination request (location service request) with message ME2 to radio network controller RNC1. The request contains information as to how the position is to be returned (e.g. as a geographic location or as an identifier for a particular district), when the information is to be returned to the higher-ranking network unit MSC1 (e.g. immediately or when the position changes) and how exactly the position is to be determined. The request is stored in radio network controller RNC1 and the necessary procedures are started in order to determine the position of the mobile phone. Some of these position determination procedures are specified in the standard so they are represented in FIG. 4 simply as a block. When the position has been determined it is stored in the currently responsible radio network controller RNC1, which is shown in FIG. 4 by block ST. The controller then returns message ME3 (location report) to the assigned higher-ranking network unit MSC1, in which this latter is notified of the position with the required accuracy.

For efficient position determination it is particularly important to forward location-services-specific information during SRNS relocation from the source radio network controller (here RNC1) to the target radio network controller RNC2. The source controller is the radio network controller that controls the mobile phone before SRNS relocation (in this example RNC1). The target controller is the radio network controller that controls the same mobile phone after SRNS relocation (in this example RNC2).

It is particularly useful for one or more location service requests and their associated information, such as the time of the expected report, the type of position information and the accuracy of the position information, to be forwarded from the source controller to the target controller during and/or after the change of responsibility of the radio network controllers. This enables immediate further processing of the position determination task (i.e. little delay for the position determination request) which the source controller (here RNC1) received before SRNS relocation from the higher-ranking network unit MSC1 but which could not be fully processed during SRNS relocation (in other words the procedure during which the mobile phone changes radio network controller) for example because the position of the mobile phone could not be determined or the position could not yet be returned in a message (location report) to the higher-ranking network unit MSC1.

It may be advantageous to send the position determination interrogation signals and also their associated information from the source controller to the target controller via existing messages, in particular via the relocation commit message. This relocation commit message is exchanged anyway between radio network controllers such as RNC1 and RNC2 via their direct connections such as LR12. The relocation commit message tells the target controller [symbol] in this case RNC2 [symbol] to perform SRNS relocation. This is advantageous because it relates to requests for information that comes from higher-ranking network elements (such as MSC1) and the container (=at least one data or information field) within the relocation commit message, which already conveys information with regard to higher-ranking network units, can be used. It would also be possible to convey the position determination requests and their associated information in an RRC container (RRC=radio resource control) which is transferred or passed in the Relocation Required messages via the connection (e.g. LRM1) from the source controller (e.g. here RNC1) to the higher-ranking network unit (here MSC1) which then forwards the container with a Relocation Request message to the target controller (here RNC2).

In addition to the position determination request, the last known position of a mobile phone in the source controller (here RNC1) may be forwarded to the target controller (here RNC2) during SRNS relocation. This is advantageous if the position of a mobile phone has already been determined by the higher-ranking network unit (such as MSC1) on the basis of a request (location services request) but it has not been possible to return a response before SRNS relocation (location report) to this higher-ranking network unit (e.g. MSC1) from the relevant radio network controller. The information on the last known position may also contain information on the accuracy of position determination.

In addition to the last known position of a mobile phone, the time at which the position was determined may be forwarded during SRNS relocation from the source controller to the target controller. This has the advantage that the target controller can use this information to estimate how up-to-date the information on the position of the mobile phone is.

It may be particularly advantageous to pass the last known position, the time of position determination and the accuracy of the existing Relocation Required message from the source controller (e.g. here RNC1) to the higher-ranking network unit (e.g. here MSC1) which forwards the information with the Relocation Request message to the target controller (e.g. here RNC2). This is advantageous because the position, time of position determination and its accuracy are information that relates to the radio network subsystem (comprising the relevant radio network controller and the assigned base stations), and the information can use the RRC container in which the radio-network-related information is forwarded. It would also be possible however to pass the information in the Relocation Commit message directly from the source controller to the target controller, which would have the advantage that only one message would have to be sent.

Exemplary Embodiment 1:

In the first exemplary embodiment it is assumed that prior to relocation two requests for determining the position of the mobile phone MP1 to be located are stored in radio network controller RNC1 which controls mobile phone MP1 prior to relocation. The following information is usefully stored per request:

The time the position is to be reported;

The type of position information;

The accuracy of the position information;

It is also assumed that no accuracy requirements are defined for the first request and that the position has already been determined. The second request is to require more accurate position determination than the previous position can provide, which is why position determination has to be performed again for the second request.

Before the position already determined for the first request can be reported to the higher-ranking network units such as MSC1 and before the position can be determined for the second request, it is assumed that the source controller (here RNC1) decides to change the radio network controller for mobile phone MP1.

FIG. 5 shows the process of SRNS relocation according to a first variant of the procedure in accordance with the invention. FIG. 1 shows the architecture and the way in which the components of the mobile communications system interact in this example. Radio network controller (source RNC) RNC1, which currently controls mobile phone MP1, takes the decision to change the radio network controller for this mobile phone MP1 (=SRNS relocation).

Described below are two ways in which position information already determined (i.e. existing position information) can be passed from the source controller to the target controller so that target controller RNC2 receives the requests after the position has been determined and can process them.

a)

In the first variant the last known position, possibly together with information on the time when the position was determined, is sent to higher-ranging network unit MSC1 in a first message SI1 (Relocation Required) together with the settings that source controller RNC1 used for mobile phone MP1. Network unit MSC1 then sends message SI2 (Relocation Request) to target radio network controller RNC2 which is to have control over the mobile phone after SRNS relocation. Target controller RNC2 is therefore aware of the last known position of mobile phone MP1 and possibly also the time when the position was determined and the accuracy of the position information if these last two items of information are included in messages SI1 and SI2. The second message contains the settings that source controller RNC1 used for controlling mobile phone MP1. Target controller RNC2 checks whether there are adequate resources available and then returns message SI3 (Relocation Request Acknowledged) to higher-ranking network unit MSC1. Network unit MSC1 then sends a fourth message (Relocation Command) SI4 to source controller RNC1 to inform it that the radio network controller for mobile phone MP1 is now to be changed. Source controller RNC1 then sends a fifth message (Relocation Commit) SI5 to target controller RNC instructing it to perform SRNS relocation. In the fifth message (Relocation Commit) SI5 the requests and their associated information or information stored in source controller RNC1 (e.g. the time the position is to be reported, the type of position information and/or its accuracy) are to be sent to target controller RNC2. Target controller RNC2 now stores these requests. Target controller RNC2 then returns a message SI6 to higher-ranking network unit MSC1 to confirm that relocation is being performed. After target controller RNC2 has configured the mobile phone (not relevant here so not shown in FIG. 5) it returns a seventh message SI7 to the higher-ranking network unit MSC1 to inform it that relocation has ended. Target controller RNC2 therefore becomes the serving RNC for mobile phone MP1. As in this exemplary embodiment it has received the position determination requests it automatically and advantageously starts the position determination process in order to respond to the second request. As it has also received the last known position and [symbol] as assumed in this example [symbol] possibly the time of position determination and possibly the accuracy of the position information from source controller RNC1, target controller RNC2 in this exemplary embodiment recognizes on the basis of the time of position determination that the position was determined recently. It therefore uses this determined position if neither the first nor the second request has made higher accuracy requirements. Target controller RNC2 then returns message SI8 (Location Report) to higher-ranking network unit MSC1 containing the position of mobile phone MP1 and representing the response to the original first request.

b)

The second variant differs from variant a) only in that the information on the last known position of mobile phone MP1 is not passed in messages SI1 (Relocation Required) and SI2 (Relocation Request) from the source controller (RNC1) to the target controller (RNC2) but is transferred together with the requests in message SI5 (Relocation Commit).

In general, the question as to which message conveys the information from the source controller to the target controller is of secondary importance. It is also conceivable, for example, that the requests for position determination and associated information (such as the time the position is to be reported, the type of position information and its accuracy) that are stored in the source controller could be included in messages SI1 (Relocation Required) and SI2 (Relocation Request) from the source controller to the target controller.

Exemplary Embodiment 2:

The second exemplary embodiment takes into account that the functions for determining the position need not necessarily be in the relevant radio network controller. It would then be possible, for example, to have the architecture of a mobile communications system MCS* that differs from that in FIG. 1, as shown in FIG. 6. Here, the position determination functionality is relocated to the serving mobile location centers SMLC1, SMLC2 which are connected via relevant fixed network connected LS1, LS2 to radio network controllers RNC1, RNC2. This preferably corresponds to an interface definition or functional breakdown of the position determination function and the other tasks of the relevant radio network controller.

In contrast to the first exemplary embodiment, it is assumed for this second exemplary embodiment that the two requests for determining the position of mobile phone MP1 are stored in mobile location center SMLC1 which is connected to radio network controller RNC1 which controls the mobile phone prior to relocation. The following information is again usefully stored per request:

The time the position is to be reported;

The type of position information;

The accuracy of the position information;

It is also assumed that the first request does not make any accuracy requirements and that the position has already been determined. The second request is to require more accurate position determination than the previous position can provide, which is why position determination is performed again for the second request.

Before the position already determined for the first request can be reported to the higher-ranking network units and before the position can be determined for the second request, it is assumed that source controller RNC1 decides to change the radio network controller for mobile phone MP1.

FIG. 7 shows the procedure for SRNS relocation. Radio network controller (source RNC) RNC1, which currently controls the mobile phone, takes the decision to change the radio network controller for this mobile phone MP1 (SRNS relocation).

The information can again be conveyed in different ways from source controller RNC1 to target controller RNC2. In this exemplary embodiment, however, only the variant described in Exemplary embodiment 1 is described.

First, source controller RNC1 instructs its assigned serving mobile location center SMLC1 in message SI01 to send all the position determination requests stored and not yet completed and also the last known position [symbol] possibly with time of determination and accuracy [symbol] to source controller RNC1. SMLC1 then sends the requested information in message SI02. In this case, this is the last known position, the time of determination and possibly its accuracy and the two requests with their above-mentioned information.

In this variant the last known position, possibly together with information on the time when the position was determined, is sent to higher-ranging network unit MSC1 in message SI1 (Relocation Required) together with the settings that source controller RNC1 used for mobile phone MP1. Network unit MSC1 then sends message SI2 (Relocation Request) to target radio network controller RNC2 which is to have control over the mobile phone after SRNS relocation. Target controller RNC2 is therefore aware of the last known position of mobile phone MP1 and possibly also the time when the position was determined and the accuracy of the position determination if these last two items of information are included in messages SI1 and SI2. The second message contains the settings that source controller RNC1 used for controlling the mobile phone. Target controller RNC2 checks whether there are adequate resources available and then returns message SI3 (Relocation Request Acknowledged) to MSC1. MSC1 then sends a fourth message (Relocation Command) SI4 to source controller RNC1 to inform it that the radio network controller for the mobile phone is now to be changed. Source controller RNC1 then sends a fifth message (Relocation Commit) SI5 to target controller RNC2 instructing it to perform SRNS relocation. The requests that are stored in source controller RNC1 are to be sent to target controller RNC2 in the fifth message (Relocation Commit) SI5. Target controller RNC2 now stores the requests. Target controller RNC2 then returns a message SI6 to higher-ranking network unit MSC1 to confirm that relocation is being performed. After target controller RNC2 has also configured the mobile phone (not relevant here so not shown in FIG. 5) it returns a seventh message SI7 to MSC1 to inform it that relocation has ended. RNC2 is therefore now the serving RNC for mobile phone MP1. Since target controller RNC2 has received the requests, it sends message SI71 to mobile location center SMLC2 containing the two requests and the last known position of mobile phone MP1, the time of position determination and possibly the accuracy. SMLC2 then starts position determination in order to respond to the second request. As it has also received the last known position and [symbol] as assumed in this example [symbol] possibly the time of position determination and possibly the accuracy of the position information, SMLC2 in this exemplary embodiment recognizes on the basis of the time of position determination that the position was determined recently. Since the first request has not defined any accuracy requirements, SMLC2 returns message SI72 to RNC2 which then returns message SI8 (Location Report) to MSC1 indicating the position of mobile phone MP1.

In general therefore, a method is provided for determining the position of at least one subscriber terminal, in particular a mobile terminal such as a mobile phone or cell phone, of a mobile communications system which has a number of base stations in associated radio cells. A first group of base stations is controlled or coordinated by at least a first radio network controller and a second group of base stations by at least a second radio network controller. During and/or after a change of responsibility from a first radio network controller to a second radio network controller at least one interrogation signal, which had been originally directed toward the first radio network controller in order to determine the position of the subscriber terminal to be located, is relayed from the first radio network controller to the second radio network controller.

The interrogation signal for determining the position is preferably made part of at least one transmission signal with which the change of responsibility between a first radio network controller and a second radio network controller is triggered or performed. This is particularly efficient in terms of signaling outlay.

In particular it may be appropriate during and/or after the change of responsibility to also transfer to the second radio network controller at least one information signal containing the position determination data already available in the first radio network controller. As available data is transferred to the second newly responsible radio network controller, the position can be determined efficiently, reliably and in particular very quickly. Preferably the data transferred in the information signal is the time the position was determined, the type of position information and/or the accuracy of the position information.

In accordance with the invention, at least one interrogation signal can be advantageously forwarded in a GSM (global system for mobile communication), UMTS (universal mobile telecommunication system), GPRS (general packet radio service), and/or EDGE (enhanced data rates for GSM environments) mobile communications system, particularly a mobile radio system.

The subscriber terminal used is preferably a mobile phone, particularly a cell phone, or other mobile information terminal. In addition, in some cases it may be of interest to locate fixed subscriber terminals in the mobile communications system such as fixed fax machines, computers, etc., for example for maintenance purposes.

1. Method for determining the position of at least one subscriber terminal (MP1) of a mobile communications system (MCS) that has a number of base stations (BS1 to BS4) in associated radio cells (CE1 to CE4), whereby a first group of base stations (BS1, BS2) is controlled by at least a first radio network controller (RNC1) and a second group of base stations (BS3, BS4) by at least a second radio network controller (RNC2),
characterized in that
during and/or after a change of responsibility from the first radio network controller (RNC1) to the second radio network controller (RNC2) at least one interrogation signal (ME1), which had been originally directed toward the first radio network controller (RNC1) in order to determine the position of the relevant subscriber terminal (MP1) to be located, is relayed from the first radio network controller (RNC1) to the second radio network controller (RNC2).

2. Method according to claim 1
characterized in that
the interrogation signal for determining the position is made part of at least one transmission signal (SI1) with which the change of responsibility is triggered and/or performed.

3. Method according to claim 1
characterized in that
during or after the change of responsibility the interrogation signal for determining the position is forwarded as a separate transmission signal from the first radio network controller (RNC1) to the second radio network controller (RNC2).

4. Method according to one of the preceding claims
characterized in that
during and/or after the change of responsibility at least one information signal (SI1) containing the position determination data already available in the first radio network controller (RNC1) is transferred to the second radio network controller (RNC2).

5. Method according to claim 4
characterized in that
the data transferred in the information signal (SI1) is the time the position was determined, the type of position information and/or the accuracy of the position information.

6. Method according to one of the preceding claims
characterized in that
at least one interrogation signal (ME1) is forwarded in a GSM (global system for mobile communication), UMTS (universal mobile telecommunication system), GPRS (general packet radio service), and/or EDGE (enhanced data rates for GSM environments) mobile communications system, particularly a mobile radio system.

7. Method according to one of the preceding claims
characterized in that
a mobile phone, particularly a cell phone is used as the subscriber terminal.

8. Mobile communication system (MCS) with a number of base stations (BS1 to BS4) in associated radio cells (CE1 to CE4), whereby at least a first radio network controller (RNC1) is assigned to a first group of base stations (BS1, BS2) and at least a second radio network controller (RNC2) is assigned to a second group of base stations (BS3, BS4), in particular in accordance with one of the preceding claims,
characterized in that
resources are provided (RNC1, RNC2, MSC) by means of which, during and/or after a change of responsibility from the first radio network controller (RNC1) to the second radio network controller (RNC2), at least one interrogation signal (ME1), which had been originally directed toward the first radio network controller (RNC1) in order to determine the position of the relevant subscriber terminal (MP1) to be located, can be relayed from the first radio network controller (RNC1) to the second radio network controller (RNC2).
